(19) United States
(12) Patent Application Publication
(10) Pub. No.: US 2003/0047442 A1
(43) Pub. Date: Mar. 13, 2003

(54) Method and implementing device for a chemical reaction

(76) Inventors: Francoise Massines, Toulouse (FR); Nicolas Gherardi, Toulouse (FR); Geradine Rames-Langlade, Chaville (FR); Alain Villermet, Viroflay (FR)

Correspondence Address: Air Liquide, Intellectual Property Department, Suite 1800, 2700 Post Oak Boulevard, Houston, TX, 77056, US

(21) Appl. No.: 10/221,762

(22) PCT Filed: Mar. 13, 2001
(86) PCT No.: PCT/FR01/00746

(51) Int. Cl. H05F 3/00

(52) U.S. Cl. 204/164

(57) ABSTRACT

The invention concerns a method for performing chemical reactions between gaseous species in accordance with a selective reaction path, by generating an electric discharge (12) in a starting gas between two energizing electrodes (23, 24) whereto is applied an electric supply voltage, so that the discharge brings about energization of at least one of the gaseous species of said starting gas. The invention is characterised in that it consists in providing the following: the starting gas includes at least a carrier gas and at least a reaction gas; the conditions of electric supply of the electrodes are adapted to enable the generation of metastable species among the species of said carrier gas, so that the ratio, in the inter-electrode space, between the concentration in said metastable species and the concentration in electrons is not less than 1.

This process for carrying out chemical reactions between gaseous constituents according to a selective reaction pathway, by creation of an electric discharge in a starting gas between two exciting electrodes to which is applied an electric supply voltage, so that the discharge excites at least a portion of the gaseous constituents of the said starting gas, is characterized by the implementation of the following measures:

the starting gas comprises at least one carrier gas and at least one reaction gas;

the electric supply conditions for the electrodes are adjusted in order to allow the creation of metastable constituents from the gaseous constituents of the said carrier gas, so that the ratio, in the interelectrode space, between the concentration of the said metastable constituents and the concentration of electrons is greater than or equal to 1.

Process and device for carrying out a chemical reaction The present invention relates to a process for carrying out chemical reactions between gaseous constituents according to a selective reaction pathway and to a corresponding device and to the application of this process and this device in the generation of a chemical compound intended for a surface treatment process.

Such an application relates very particularly to treatments which make it possible to modify the surface characteristics of a material, in particular of a polymer film, for the purpose, for example, of modifying its wettability, or to graft chemical bonds to the surface of a substrate which are capable of improving the adhesion of a subsequent coating.

In particular, the invention relates to a process and a device for carrying out chemical reactions between gaseous constituents according to a selective reaction pathway, according to which reactions the constituents are excited by means of an electric discharge maintained in an appropriate starting gas, such that the desired reaction pathways (taking into account the targeted technical objective) between the chemical constituents are initiated and maintained.

Electric discharges, by their very nature, make it possible to carry out chemical reactions which are difficult to envisage when use is made of conventional means, such as activation by heating or alternatively catalysis, and the like. This is because, as a plasma generated under the action of such an electric discharge is a partially ionized medium, it comprises chemical constituents which are excited to sometimes very high energy levels (metastable constituents).

An electric discharge is generally governed by successive collisions of electrons with the compounds of the gas or the gas mixture. As the energy levels of the electrons are distributed according to a fairly broad distribution function, the reaction processes generated by the collisions with electrons create numerous constituents with very different energy levels.

This results in many reaction pathways leading to the creation of a multitude of constituents, including undesired reaction pathways leading to undesirable compounds (by way of illustration, in the formation of silica powder in the case of a discharge carried out in a gas mixture comprising a silane and an oxidant).

Attempts have been made to overcome the abovementioned disadvantages by improving the selectivity of the process in which the excited constituents are created by controlling either the composition of the starting mixture or the excitation alternating voltage.

The improvement in the selectivity by controlling the composition of the gas mixture makes it possible either to favour certain chemical reactions or reaction pathways (for example, by providing an excess of a compound in the mixture) or to limit certain reaction pathways by the addition, for example, of a compound which carries out the role of scavenging a targeted chemical constituent.

However, this technique exhibits a relatively low selectivity in so far as it does not make it possible to completely prevent reaction pathways which lead to undesirable products.

The improvement in the selectivity by controlling the excitation voltage is generally obtained by using an alternating voltage with a signal with a very fast rise time and with a high voltage. The constituents are then excited to a high energy level and chemical pathways employing constituents with a low energy level are avoided. However, the latter technique exhibits a very low selectivity for reaction mechanisms involving constituents with a high energy level.

Reference may also be made to the studies by the Applicant Company which are reported in Patent Application PCT/FR99/01932 of Aug. 4, 1999, which relates to the conditions for obtaining a homogeneous discharge in a gas (and therefore a non-filamentary discharge) and to the extremely positive consequences of the use of such homogeneous discharges in processes for the surface treatment of polymer substrates.

The aim of the invention is to overcome the abovementioned disadvantages.

A subject-matter of the invention is therefore a process for carrying out chemical reactions between gaseous constituents according to a selective reaction pathway, by creation of an electric discharge in a starting gas between two exciting electrodes to which is applied an electric supply voltage, so that the discharge excites at least a portion of the gaseous constituents of the said starting gas, characterized by the implementation of the following measures:

the starting gas comprises at least one carrier gas and at least one reaction gas;

the electric supply conditions for the electrodes are adjusted in order to allow the creation of metastable constituents from the gaseous constituents of the said carrier gas, so that the ratio, in the interelectrode space, between the concentration of the said metastable constituents and the concentration of electrons is greater than or equal to 1.

This process can also comprise one or more of the following characteristics, taken in isolation or according to any technically possible combination:

the carrier gas is chosen so that the energy level of its metastable constituents thus created by electric discharge is equal to or slightly greater than the excitation energy level of the constituents of the said at least one reaction gas,

the peak-to-peak supply voltage is between approximately 1 kV and 30 kV and the frequency of the latter is between approximately 200 Hz and 100 kHz,

the frequency of the supply voltage is less than 15 kHz,

the carrier gas comprises at least one of the gases chosen from nitrogen, argon, helium, krypton and xenon,

the carrier gas comprises nitrogen or argon and the said at least one reaction gas comprises, on the one hand, oxygen or a gas capable of releasing oxygen, for example N₂O, and, on the other hand, a gaseous silicon precursor, for example monosilane SiH₄.

Another subject-matter of the invention is a device for carrying out chemical reactions between gaseous constituents according to a selective reaction pathway which comprises two exciting electrodes, electric supply means for the exciting electrodes and means for supplying the interelectrode space with a starting gas in which a discharge has to be created under the action of the exciting electrodes, which electrodes are capable of exciting at least a portion of the gaseous constituents of the said starting gas, characterized by the implementation of the following measures:

the said starting gas comprises at least one carrier gas and at least one reaction gas,

the said electric supply means are adjusted in order to allow the creation of metastable constituents from the gaseous constituents of the said carrier gas, so that the ratio, in the interelectrode space, between the concentration of the said metastable constituents and the concentration of electrons is greater than or equal to 1.

The carrier gas is preferably chosen so that the energy level of its metastable constituents thus created by electric discharge is equal to or slightly greater than the excitation energy level of the constituents of the said at least one reaction gas.

The said electric supply means are advantageously adjusted in order to create a peak-to-peak supply voltage of between approximately 1 kV and 30 kV and a frequency of the latter which is between approximately 200 Hz and 100 kHz.

Advantageously again, the said electric supply means are adjusted in order to create a supply voltage with a frequency of less than 15 kHz.

Finally, another subject-matter of the invention is a process for the treatment of a surface by deposition of a silicon oxide on the latter, characterized in that the compound deposited is obtained by implementing a process (such as described above) for carrying out chemical reactions according to a selective reaction pathway between N₂O and SiH₄ using a carrier gas composed of nitrogen, the said selective reaction pathway making it possible to prevent the nucleation of silica powder in the interelectrode space.

Other characteristics and advantages will emerge from the following description, which is given solely by way of example and with reference to the appended drawings, in which:

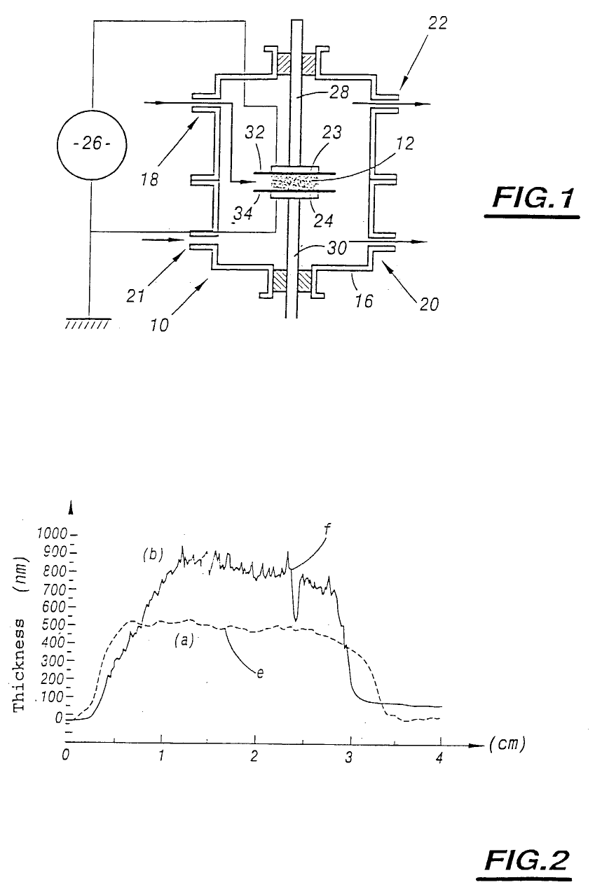

FIG. 1 is a diagrammatic sectional view of a device which makes it possible to carry out selective chemical reactions according to the invention;

FIG. 2 is a curve showing the change in the thickness of a deposit obtained by discharge conditions in accordance with the invention (curve e) and by a filamentary discharge, i.e. governed by collisions with electrons (curve f).

A device for carrying out chemical reactions in accordance with the invention, denoted by the general numerical reference 10, has been represented diagrammatically in FIG. 1.

It is intended to generate a homogeneous discharge 12 in a starting gas to cause excitation of gaseous constituents, in order to initiate and maintain a chemical reaction between these constituents.

The device 10 comprises a reactor 16 provided with a first injection orifice 18 in communication with a source for supplying carrier gas (not represented), for example composed of nitrogen, of argon or of helium.

Furthermore, the reactor 16 possesses an inlet 21 for a reaction gas mixture, for example a mixture of a silane and of an oxidizing gas.

It is seen, of course, that the carrier gas+reaction gas mixture overall mixture could be introduced into the reactor at a single gas inlet and not at two separate inlets, as is the case in FIG. 1.

The presence in the represented device of two gas outlets 20 and 22 will also be noted (here again, it will have been understood that the plant could, without at any time departing from the scope of the present invention, comprise only a single gas discharge means).

Two exciting electrodes 23 and 24 extend in parallel inside the reactor 16.

They are, for example, each composed of a metal disc and are each connected to a source 26 for supplying alternating voltage, the applied voltage and the excitation frequency of which can be adjusted according to a predetermined range.

Furthermore, they are each supported by an adjustable rod, 28 and 30 respectively, which are accessible from the outside of the reactor 16, so as to adjust the interelectrode gas space according to a range of between, for example, approximately 0.5 and 5 mm.

As mentioned above, the discharge 12 is obtained by exciting the electrodes 23 and 24 by means of the supply source 26. In order to do this, and for the purpose of obtaining a homogeneous discharge 12, that is to say a non-filamentary discharge, the supply voltage is fixed at a value of, for example, between approximately 1 kV and 30 kV, considered peak-to-peak, and the frequency of the excitation voltage supplied between the electrodes 23 and 24 is between approximately 200 Hz and 100 kHz, preferably below 15 kHz, this being a function of the thickness of the interelectrode gas space, of the flow of the starting gas and of the composition of the latter.

Thus, by way of illustration, in the case of nitrogen, for an interelectrode distance in the region of 1 mm, the peak-to-peak value of the supply voltage adopted is advantageously in the region of 11 kV, the latter advantageously being equal to 24 kV when the interelectrode distance is, for example, equal to 3 mm.

As will have been understood on reading everything which precedes, controlling the operating conditions for discharge according to the present invention makes it possible to create, in the electric discharge, amounts of metastable constituents of the starting gas such that the concentration of these metastable constituents in the interelectrode space is greater than the concentration of the electrons. Thus, the reaction mechanisms created between the constituents of the gas or of the gas mixtures are then, for the most part, controlled by the interactions which involve the metastable constituents of the carrier gas.

Furthermore, as each metastable constituent of a gas has a unique well defined energy level, unlike the electrons, the energy levels of which are distributed according to a fairly broad distribution function, the abovementioned operating conditions make it possible to obtain great selectivity for the reaction pathways implemented.

Moreover, as the metastable constituents are neutral chemical constituents, they are sensitive, unlike charged constituents, neither to the value of nor to the variations in the electric field. Thus, whereas the concentration of charged constituents decreases very rapidly and their speed becomes substantially zero between two alternations in the excitation voltage, the metastable constituents remain present in proportions which are kept high and are uniformly distributed in the reactor 16.

Consequently, between two alternations in the excitation voltage, that is to say when the charged constituents become rare and substantially immobile, the reactions involving these constituents become insignificant. On the other hand, as the metastable constituents remain numerous and predominant, the reactions carried out are to a predominant extent those which involve them, that is to say the reactions in which the metastable constituents transfer their energy to the constituents of the reaction gas mixture, with which they react to form either ions of the these same constituents or constituents with a higher energy level.

Of course, such reactions only take place statistically (i.e. in significant proportions) when the energy level of a metastable constituent is equal to or slightly greater than the dissociation energy of these chemical constituents.

A person skilled in the art is familiar with this notion of energy level of a metastable constituent equal to or “slightly greater” than the dissociation energy of a given constituent, which statistically promotes the transfer of energy between two entities: it is most commonly considered in the literature that this terminology applies to a difference in energy level of 2 eV and less.

As the energy level of each metastable constituent is fixed and specific to the gases from which they result, the reactions requiring an energy contribution equal to or slightly lower than the energy level of this metastable constituent are, statistically, very strongly predominant. The selectivity for the reaction pathways implemented is thus greatly increased by the choice of the metastable constituents created: the choice of the metastable constituents created conditions the possibilities of energy transfer to the constituents of the reaction mixture and thus the ions and metastables created in this reaction mixture and thus, for this reason, the reaction pathways in the starting gas mixture which may or may not emerge.

It is consequently seen that the choice of the carrier gas and thus of the energy level of its metastable constituents thus created under the action of a well controlled electric discharge makes it possible to select the reaction pathways arising between the various constituents present in the interelectrode space.4

It will thus have been understood that, when it is desired to obtain a reaction constituent requiring a well defined energy level, it is sufficient to select the carrier gas according to the energy levels of its metastable constituents in order for these levels to be equal to or slightly greater than the energy level necessary in order to obtain the desired constituent.

Thus, for example, the carrier gas can be chosen from nitrogen, argon, helium, krypton, neon and xenon.

Consideration is given hereinbelow to the case where the carrier gas comprises nitrogen and where the reaction gas mixture comprises, on the one hand, oxygen or a gas capable of releasing oxygen, such as N₂O, and, on the other hand, a silicon precursor, in particular SiH₄ (applicational example for the deposition of a layer of silicon oxide on a substrate).

An example of carrying out chemical reactions between N₂O and SiH₄ will now be described. In this case, use is made of a starting gas composed of N₂ comprising approximately 50 ppm of SiH₄ and 800 ppm of N₂O.

By choosing the operating conditions as mentioned above so that the electric discharge is homogeneous and taking into account the fact that nitrogen is very strongly predominant in the reactor, the chemical reactions between SiH₄ and N₂O are mainly initiated and maintained by the metastable nitrogen constituents denoted hereinbelow by N₂^{★}.

The chemical reactions implemented are essentially the following:

N₂^{★}+N₂^{★}→N₄⁺+e⁻ (1)

and

N₂^{★}+N₂O→N₂+N^{●}+NO^{●} (2)

The first reaction (1) is the actual source of the homogeneity of the plasma.

The second reaction (2) is the initiation reaction for the reaction mechanisms implemented in the plasma. The three excited constituents produced by this reaction (2), namely N₂, N^{●} and NO^{●}, can themselves theoretically react with other constituents present in the plasma to produce new excited constituents. However, as N₂ is the molecule in its fundamental state, it cannot transfer energy to another constituent and is therefore not the source of other reaction mechanisms.

NO^{●} is itself capable of reacting in a high proportion with the molecule SiH₄ to form an intermediate constituent of general formula SiH_{y}NOₓ.

A filamentary electric discharge, that is to say governed by collisions with electrons, would result, in replacement of the reaction (2), in a dissociation reaction of N₂O to N₂+O^{●}. The constituent O^{●} then reacts in the gas phase with SiH₄ to form silica. This results in the formation of silica powder, which is deposited on all the constituents of the discharge region and prevents, by its accumulation, the continuous operation of the process.

It is then seen, in FIG. 2, that the process which has just been described can be used to carry out deposition of SiOₓ on a substrate, for example on a silicon substrate, in this instance for a starting gas mixture of nitrogen comprising 800 ppm of N₂O and 50 ppm of SiH₄, that is to say an N₂O/SiH₄ ratio of 16.

This figure clearly shows the fact that a substrate treated by means of a homogeneous discharge (curve e) exhibits a more homogeneous deposition thickness; the substrate thus treated is not as rough as a substrate treated by means of a filamentary discharge (curve f).

The silicon oxide deposits obtained according to the invention were tested in order to characterize their electrical properties and more particularly the dielectric capacity. Thus, the process which has just been described was used to deposit SiOₓ on a silicon substrate. A metallization was subsequently carried out on the SiOₓ deposit by a conventional method. The principle of the tests carried out consists in measuring the dielectric capacity of the SiOₓ deposit by applying, between the silicon substrate and the metallization, while varying it, a continuous voltage to which is added a sinusoidal voltage of low amplitude.

Such a measurement of capacity makes it possible to demonstrate the continuous or noncontinuous nature of the SiOₓ deposit. This is because, if the SiOₓ deposit is not continuous, the metallization produced on this deposit comes into contact with a portion of the silicon substrate and application of the voltage then creates a short-circuit, rendering it impossible to measure the dielectric capacity of the SiOₓ deposit. This situation is observed when the SiOₓ deposit is produced by a filamentary discharge. On the other hand, as has been possible to demonstrate here, when the SiOₓ deposit is obtained according to the invention, that is to say by homogeneous discharge, no short-circuit is observed and it then becomes possible to measure the dielectric capacity of the deposit, which shows that the SiOₓ deposit obtained according to the invention is indeed continuous.

1. Process for carrying out chemical reactions between gaseous constituents according to a selective reaction pathway, by creation of an electric discharge in a starting gas between two exciting electrodes to which is applied an electric supply voltage, so that the discharge excites at least a portion of the gaseous constituents of the said starting gas, characterized by the implementation of the following measures:
the starting gas comprises at least one carrier gas and at least one reaction gas;
the electric supply conditions for the electrodes are adjusted in order to allow the creation of metastable constituents from the gaseous constituents of the said carrier gas, so that the ratio, in the interelectrode space, between the concentration of the said metastable constituents and the concentration of electrons is greater than or equal to 1.

2. Process according to claim 1, characterized in that the carrier gas is chosen so that the energy level of its metastable constituents thus created by electric discharge is equal to or slightly greater than the excitation energy level of the constituents of the said at least one reaction gas.

3. Process according to either of claims 1 and 2, characterized in that the peak-to-peak supply voltage is between approximately 1 kV and 30 kV and the frequency of the latter is between approximately 200 Hz and 100 kHz.

4. Process according to claim 3, characterized in that the frequency of the supply voltage is less than 15 kHz.

5. Process according to any one of claims 1 to 4, characterized in that the carrier gas comprises at least one of the gases chosen from nitrogen, argon, helium, krypton and xenon.

6. Process according to claim 5, characterized in that the carrier gas comprises nitrogen or argon and in that the said at least one reaction gas comprises, on the one hand, oxygen or a gas capable of releasing oxygen, such as N₂O, and, on the other hand, a gaseous silicon precursor, such as monosilane SiH₄.

7. Device for carrying out chemical reactions between gaseous constituents according to a selective reaction pathway which comprises two exciting electrodes (23, 24), electric supply means for the exciting electrodes and means for supplying the interelectrode space with a starting gas in which a discharge has to be created under the action of the exciting electrodes, which electrodes are capable of exciting at least a portion of the gaseous constituents of the said starting gas, characterized by the implementation of the following measures:
the said starting gas comprises at least one carrier gas and at least one reaction gas (18, 20, 21, 22),
the said electric supply means are adjusted in order to allow the creation of metastable constituents from the gaseous constituents of the said carrier gas, so that the ratio, in the interelectrode space, between the concentration of the said metastable constituents and the concentration of electrons is greater than or equal to 1.

8. Device according to claim 7, characterized in that the carrier gas is chosen so that the energy level of its metastable constituents thus created by electric discharge is equal to or slightly greater than the excitation energy level of the constituents of the said at least one reaction gas.

9. Device according to either of claims 7 and 8, characterized in that the said electric supply means are adjusted in order to create a peak-to-peak supply voltage of between approximately 1 kV and 30 kV and a frequency of the latter which is between approximately 200 Hz and 100 kHz.

10. Device according to claim 9, characterized in that the said electric supply means are adjusted in order to create a supply voltage with a frequency of less than 15 kHz.

11. Process for the treatment of a surface by depositing a silicon oxide on the latter, characterized in that the compound deposited is obtained by means of a process for carrying out chemical reactions between gaseous constituents according to a selective reaction pathway in accordance with any one of claims 1 to 6, the said carrier gas being composed of nitrogen and the said reaction gas comprising N₂O and SiH₄, the said selective reaction pathway making it possible to prevent the nucleation of silica powder in the interelectrode space.

12. Surface treatment process according to claim 11, characterized in that the deposit thus produced is substantially continuous.
